(19) United States
(12) Patent Application Publication
(10) Pub. No.: US 2025/0321013 A1
(43) Pub. Date: Oct. 16, 2025

(54) CONDENSER APPARATUS AND METHOD FOR REMOVING WATER FROM AIR

(71) Applicant: ARESCO Technologies, LLC, Omaha, NE (US)

(72) Inventor: John Lingelbach, Omaha, NE (US)

(21) Appl. No.: 19/174,589

(22) Filed: Apr. 9, 2025

Related U.S. Application Data
(60) Provisional application No. 63/632,220, filed on Apr. 10, 2024.

(51) Int. Cl. F24F 1/0059

(52) U.S. Cl. CPC F24F 1/0059

(57) ABSTRACT

A condenser apparatus and a method of removing water from air. The condenser apparatus includes: (a) a housing for directing air flow within the housing, and having an air inlet and an air outlet; (b) a cross flow heat exchanger having a first air inlet, a first air outlet, a second air inlet, and a second air outlet; (c) an airflow driver for driving airflow through at least a portion of the housing; (d) a water condenser having an air inlet for receiving air flowing from the first air outlet of the cross flow heat exchanger, an air outlet for providing air to the second air inlet of the cross flow heat exchanger, a fluid inlet, and a fluid outlet, wherein heat is transferred from air flowing into the air inlet to fluid flowing from the fluid inlet to the fluid outlet; and (e) a condensate collector for collecting water condensate from the air flowing into the air inlet of the water condenser.

### CROSS REFERENCE TO RELATED APPLICATION

This application claims priority to U.S. Provisional Application No. 63/632,220 filed on Apr. 10, 2024, the entire contents of which are incorporated herein by reference.

### FIELD OF THE DISCLOSURE

This disclosure relates to a condenser apparatus and to a method of removing water from air. In general, the condenser apparatus and the method for removing water from air involve utilizing cooled air to cool incoming air prior to processing the air in a water condenser for the recovery of water therefrom.

### BACKGROUND

Various techniques are being utilized for providing water in areas where there is a need for water but where clean sources of water in the form of rivers, lakes, and aquifers is generally not available. Certain techniques for obtaining water that are very energy intensive and/or contribute to significant pollution. Exemplary techniques include obtaining water from seawater either by distillation or by reverse osmosis. In both techniques, the resulting brine needs to be disposed of and is often dumped back into the ocean where it alters the local salt concentration. Considerable attention has been directed at condensing water from air utilizing, for example, radiative cooling.

Air conditioning and refrigeration systems have been utilized to cool air by lowering the temperature of the air and by removing humidity or moisture from the air. In such air conditioning and refrigeration systems, the water removed from the air is typically a byproduct and is discarded.

### SUMMARY

The disclosure includes a condenser apparatus. The condenser apparatus includes: (a) a housing for directing air flow within the housing, and having an air inlet and an air outlet; (b) a cross flow heat exchanger having a first air inlet, a first air outlet, a second air inlet, and a second air outlet; (c) an airflow driver for driving airflow through at least a portion of the housing; (d) a water condenser having an air inlet for receiving air flowing from the first air outlet of the cross flow heat exchanger, an air outlet for providing air to the second air inlet of the cross flow heat exchanger, a fluid inlet, and a fluid outlet, wherein heat is transferred from air flowing into the air inlet to fluid flowing from the fluid inlet to the fluid outlet; and (e) a condensate collector for collecting water condensate from the air flowing into the air inlet of the water condenser.

The disclosure includes a method of removing water from air. The method includes: (a) flowing ambient air into a condenser apparatus housing and cooling the ambient air with processed air in a cross flow heat exchanger that separates the ambient air and the processed air and allows heat transfer to provide cooled ambient air; (b) further cooling the cooled ambient air in a water condenser to remove water from the cooled ambient air and lower the temperature of the cooled ambient air to provide the processed air, wherein the processed air contains less water than the ambient air and is provided at a temperature lower than the ambient air; and (c) collecting the water removed from the cooled ambient air in the water condenser.

### BRIEF DESCRIPTION OF THE DRAWINGS

Embodiments of the invention are further described in the following figures, but are not limited by following figures.

FIG. 1 is a schematic illustration of a condenser apparatus according to the present disclosure.

FIG. 2 is a schematic illustration of an alternative embodiment of a condenser apparatus according to the present disclosure.

### DETAILED DESCRIPTION

A condenser apparatus and a method for removing water from air are provided by this disclosure. The condenser apparatus and the method for removing water from air can be utilized in areas or locations where there is a need for water, such as in any water need environment including, for example, drinking water, irrigation, industrial, agricultural, or domestic use. Because the condenser apparatus and the method are provided for recovering liquid water from air, it may be advantageous to provide the apparatus and method in locations where water vapor is readily available. Such locations generally include humid areas in the regions of the tropics, in areas where there are large bodies of water that create humid conditions, and where water is taken up resulting in humid conditions. In addition, because warm air can hold significantly more water than cold air, these humid areas may also be areas that have generally warm air, perhaps even tropical air.

While air conditioning and refrigeration systems are typically designed to provide a lowering of air temperature or a cooling effect, this operation often results in removal of water from air. This approach, however, tries to maximize the recovery of cool air that is incidentally less humid air. The water removed by air conditioning is often a waste product and is simply discarded by allowing it to drain away. The present disclosure is different at least because the focus is on maximizing the recovery of water from air, and where it is not necessarily sought to recover cooled air. In fact, the present disclosure provides for using the cooled air to remove heat from incoming humid air. The present disclosure is based on the appreciation that air that has been cooled and processed for the removal of water therefrom in a condenser apparatus can be used as a source for cooling, or removing heat from, air entering the condenser apparatus. The cooling of the air entering the condenser apparatus can take place in a heat exchanger such as a cross flow heat exchanger where the two air streams are not mixed. The air entering the condenser apparatus can be referred to as inlet air. The inlet air can be referred to as ambient air when it is the air taken in from the outdoors environment and without any significant processing for the removal of water therefrom. Of course, the air entering the condenser apparatus can be processed in some manner, and need not be ambient air. For example, the air entering the condenser apparatus can be a process stream from another operation where the process stream may have a relatively high level of moisture therein. Furthermore, the inlet air can be processed by filtration for the removal of particulates or other substances.

The inlet air cooled by the heat exchanger can be referred to as cooled inlet air, and the air processed through a water condenser can be referred to as processed air. The processed air can then be fed to the heat exchanger, such as a cross flow heat exchanger, for cooling the inlet air, and the resulting processed air from the heat exchanger can, if desired, be used, alone or in combination with additional air, for removing heat from the heat transfer media that circulates in the water condenser and collects heat from the cooled inlet air. The heat transfer media that circulates in the water condenser can be a refrigerant and can flow through a condenser for condensing the refrigerant. Accordingly, the processed air following the heat exchanger (for example, the cross flow heat exchanger) can be used alone or with other air for cooling the condenser that condenses the refrigerant. This can reduce discharge pressure, and may be especially useful for applications that use carbon dioxide as a refrigerant, as it reduces the chances that a carbon dioxide refrigeration system will need to go into a super-critical condition.

An additional advantage of the condenser apparatus is that the inlet air may be taken below the dew point while being cooled in the heat exchanger (for example, the cross flow heat exchanger) thereby allowing for an additional surface are that provides for condensing water, and the condensed water can be collected.

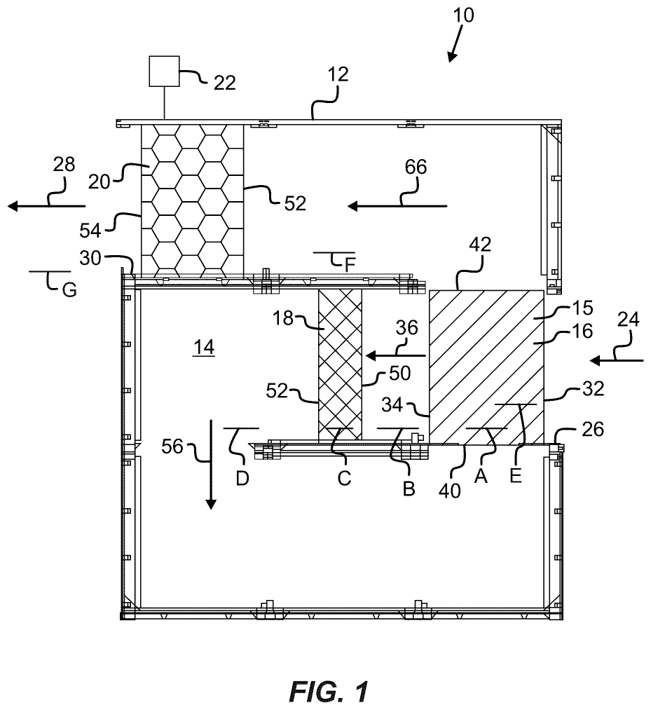

Now referring to FIG. 1, a condenser apparatus is illustrated at reference number 10. The condenser apparatus 10 includes a housing 12 that provides an internal flow arrangement 14 for air to flow through the housing 12. Also provided in the condenser apparatus 10 are a heat exchanger 15 such as a cross flow heat exchanger 16, a water condenser 18, an airflow driver 20, and, optionally, a control unit 22 that provides for operational monitoring and control of the condenser apparatus 10.

The condenser apparatus 10 can receive inlet air 24 from outside of the condenser apparatus 10, and into the housing 12 via the housing air inlet 26, and can discharge outlet air 28 out of the housing via the housing air outlet 30. The inlet air 24 can be referred to as ambient air or outside air and refers to the air outside of the condenser apparatus 10 that is provided for flow into the condenser apparatus 10 for recovery of water vapor therefrom. The reference to ambient air is in general a reference to atmospheric air that comes in from the atmosphere without any processing other than filtration for removal of dust or other particulates. There is no requirement that only ambient air be processed by the condenser apparatus 10. Of course, the air to be processed by the condenser apparatus 10 can be subjected to processing, in addition to or alternative to filtration, prior to entry into the condenser apparatus 10. For example, the air may be air from another process that may increase or enhance the amount of water vapor therein, or it may be an outlet flow from another process that can then be introduced into the condenser apparatus 10. The other process may be an industrial process or an agricultural process where humid air is a by-product, and where the humid air by-product can be processed for the removal of water therefrom and the potential recovery of the removed water.

The airflow through the housing 12 can be driven by a driver 20, and the driver 20 can be a fan or multiple fans in any acceptable arrangement along the internal flow arrangement 14 so that it drives the flow of air therethrough. The condenser apparatus 10 can provide for an air flow path that provides for at least one reversal of air flow, and preferably at least two reversals of air flow, in flow through the internal flow arrangement 14 from the housing air inlet 26 to the housing air outlet 30. A single reversal of air flow can be considered about 180 degrees, and at least two reversals of air flow can be considered about 360 degrees. The air flow can be provided as about 270 degrees when caused to flow through both passageways of a cross flow heat exchanger in which case the air can be discharged from the housing and need not be turned an additional 90 degrees.

Air entering the condenser apparatus 10 via the housing air inlet 26 flows along a first passageway through cross flow heat exchanger 16 from the first air inlet 32 to the first air outlet 34. The air exiting the first air outlet 34 can be referred to as cooled inlet air or cooled ambient air 36. During flow through the cross flow heat exchanger 16, the inlet air 24 exchanges heat with air flowing through a second passageway through the cross flow heat exchanger 16 from the second air inlet 40 to the second air outlet 42. Preferably, there is no mixing of air in the first passageway with air in the second passageway, but alternatives are possible. During flow through the first passageway, the inlet air 24 can lose at least about 2 degrees F. and preferably loses about at least about 5 degrees F. when it exits as cooled inlet air 36. The extent of cooling of the inlet air can be, for example, about 2 degrees F. to about 14 degrees F., or about 5 degrees F. to about 12 degrees F., but of course the amount of cooling may depend on the inlet air temperature with higher inlet air temperatures likely seeing larger temperature drops. An advantage of cooling the inlet air 24 prior to flow into the water condenser 18 is that less energy is needed to operate the condenser apparatus 10 and more energy can be directed to obtaining water condensate from the air. The cross flow heat exchanger 16 illustrated uses an air-to-air method to exchange heat. Other methods and heat exchanger types that can be incorporated including pumped water, heat pipe, etc., with the advantage that the cooled air from the water condenser 18 is used to cool the inlet air 24 prior to the inlet air 24 being introduced into the water condenser 18.

The cooled inlet air 36 then flows through the water condenser 18 from the water condenser air inlet 50 to the water condenser air outlet 52. During flow through the water condenser 18, the cooled inlet air 36 is further cooled so that water vapor in the air is condensed and can be recovered by a condensate collector. The air flowing out of the water condenser 18 can be referred to as processed air 56 because it has been processed for removal of water vapor therefrom as a result of flowing through the water condenser 18. In order to provide for a reduction in the temperature of the cooled inlet air 36 in the water condenser 18, a cooling media can be caused to flow through the water condenser 18 but separated from the cooled inlet air 36. Exemplary cooling media include refrigerants and non-refrigerant materials. Exemplary refrigerants include typical refrigerants used in refrigeration and air conditioning including, for example, carbon dioxide, ammonia, and fluorocarbons such as hydrochloroflourocarbons, chloroflourocarbons, hydroflourocarbons, hydrocarbons, etc. Exemplary sources of non-refrigerant cooling media water from cool sources such as large bodies of water or media that has exchanged heat with water from large bodies of water (i.e., ocean water). The water used as cooling media can be pure water or it can have other components therein including salt or other chemicals. In the case of refrigerants used for providing a source of cooling, one would understand how the refrigerant can be used to provide a cooling effect in a condenser.

The processed air 56 exiting the water condenser 18 via the water condenser outlet 52 can be used as a cool air for flow through the second passageway of the cross flow heat exchanger 16 via the second air inlet 40 to the second air outlet 42. As illustrated, the processed air 56 flows through the internal flow arrangement 14 so that it can be used for heat exchange with the inlet air 24. Accordingly, the inlet air 24 is caused to rotate at least 270 degrees in order to act as a heat transfer fluid once it becomes the processed air 56 for exchanging heat with the inlet air 24.

If the processed air 36 is colder than the incoming inlet air 24, and if it is below the dew point of the incoming inlet air 24, it is possible that water will condense in the cross flow heat exchanger 16. Water condensed from in cross flow heat exchanger 16 or as a result of flow therethrough can also be recovered.

Typically, the processed air 56 leaving the cross flow heat exchanger 16 becomes warmed as a result of heat transfer in the cross flow heat exchanger 16, and can be referred to as warmed processed air 66. The warmed processed air 66 is generally not warmed to an extent that it is as warm or warmer than the inlet air 24. That is, the warmed processed air 66 is typically several degrees, i.e., at least about 2 degrees, cooler than the inlet air 24. As a result, the warmed processed air 66 can be directed to a condenser or group of condensers. The condenser or group of condensers can be located on either or both sides of the driver 20. As illustrated, the warmed processed air 66 can flow through the driver inlet 52 and out through the driver outlet 54. It is also noted, that the driver 20 can be provided as a single fan or as multiple fans and can be located throughout the internal airflow arrangement 14, and the condenser or group of condensers can be located anywhere along the internal airflow arrangement 14 downstream of the cross flow heat exchanger 16. Using the warmed processed air 66 to assist in condensing refrigerant further increases energy efficiency.

The condensed water can be recovered at any location along the internal flow arrangement. For example, a water collection pan A can be provided as part of the heat exchanger 15, a water collection pan B can be located between the heat exchanger 15 and the water condenser 18, a water collection pan C can be located in the water condenser 18, a water collection pan D can be located between the water condenser 18 and the heat exchanger 15, and water collection pans E, F, and G can be located in/or downstream of the heat exchanger 1, as illustrated. An advantage of having a water collection pan at various locations including downstream of the water condenser 18 is that the air flow through the water condenser 18 need not be limited so that condensed water is not blown off the coils or other surface area inside the water condenser 18. That is, the condensed water can be blown out of the water condenser 18, or any other process equipment, because of a high air flow rate, for example, through the water condenser 18, and collected downstream. Although it is generally expected that not much, relatively, of liquid water will be recovered from the heat exchanger 15 compared to the condenser 18, it is nevertheless advantageous that condensed water can be recovered in and downstream of the heat exchanger 15 thereby permitting higher air flow rates therethrough. Because the desired end product is condensed water as opposed to cooled air, higher air flow rates through the condenser apparatus 10 may be advantageous.

The control unit 22 may provide control of the condenser apparatus 10 to provide desired condensed water as a preferred product. Thus, the control unit 22 may adjust the air flow via the airflow driver 20 and coil temperature within the water condenser 18. The control unit 22 can receive inputs including, for example, inlet air temperature, inlet air humidity, outlet air temperature, outlet air humidity, and air temperatures and air flow rates throughout the internal flow arrangement 14.

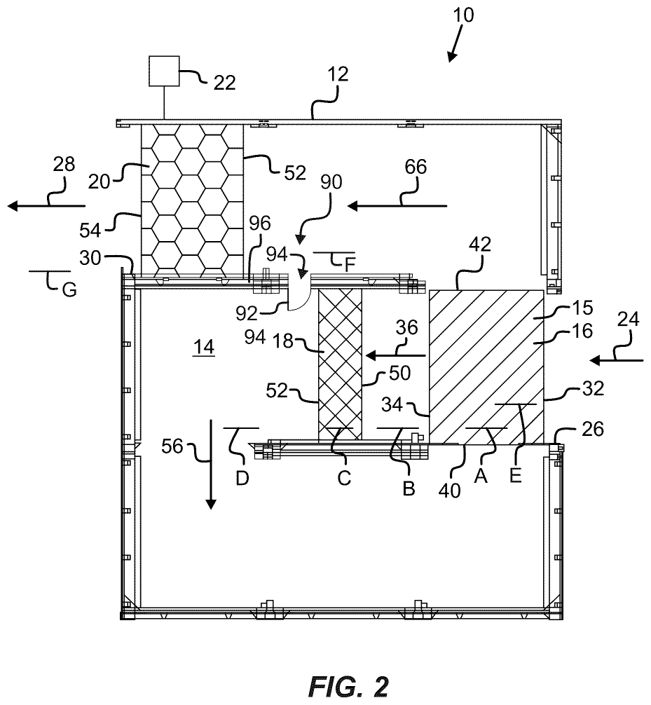

An alternative embodiment of the condenser apparatus and method is illustrated in FIG. 2 where the same reference number are used as in FIG. 1. In FIG. 2, there is a port opening allowing mixing of the processed air 56 with the warmed processed air 66 without the processed air 56 passing through the second passageway of the cross flow heat exchanger 16. That is, the processed air 56 can flow through a bypass opening 90 that permits at least part of the processed air 56 to bypass the second passageway of the cross flow heat exchanger 16. The bypass opening 90 can include a door 92 and a port opening 94, wherein the door 92 permits opening and closing of the port opening 94. It is also noted that the bypass opening 90 is shown located between a wall 96 separating the bulk flow of the processed air 56 and the warmed processed air 66, and the bypass opening can be located elsewhere where it will provide bypass of the cross flow heat exchanger 16, such as, for example, to a location downstream of the driver 20 so that the resulting outlet air 28 includes some mount of the processed air 56 that has not been subject to flow through the cross flow heat exchanger, or the bypass opening 90 can be placed to that a portion of the processed air 56 is separately recovered where it need not mix with the warmed processed air 66.

The alternative embodiment of FIG. 2 may be advantageous when it is desired to reduce the temperature of the heated process air 66 from the cross flow heat exchanger 16. For example, the outlet air 28 may be exhausted to the environment, or it may be utilized in a downstream process. An exemplary downstream application may be a heat generating environment where it is desired to utilize the outlet air 28, which is likely cooler that the ambient air 26, and most certainly is less humid than the ambient air 26, to provide a cooling effect in the heat generating downstream process. An exemplary downstream process includes a data center which traditionally have issues with generating too much heat that needs to be removed. To improve the performance of the outlet air 28 in such applications, for example, it is possible to mix a portion of the processed air 56 with the heated processed air 66 thereby reducing the temperature of the resulting outlet air 28 and also reduce the relative humidity of the outlet air 28. The reduced temperature and/or reduced relative humidity of the outlet air, as a result of providing bypass flow, may allow the outlet air 28 to be more beneficial for removing heat from downstream heat generating applications. The above specification provides a complete description of the manufacture and use of the invention. Since many embodiments of the invention can be made without departing from the spirit and scope of the invention, the invention resides in the claims hereinafter appended.

What is claimed is:

1. A condenser apparatus comprising:
(a) a housing for directing air flow within the housing, and having an air inlet and an air outlet;
(b) a cross flow heat exchanger having a first air inlet, a first air outlet, a second air inlet, and a second air outlet;
(c) an airflow driver for driving airflow through at least a portion of the housing;
(d) a water condenser having an air inlet for receiving air flowing from the first air outlet of the cross flow heat exchanger, an air outlet for providing air to the second air inlet of the cross flow heat exchanger, a fluid inlet, and a fluid outlet, wherein heat is transferred from air flowing into the air inlet to fluid flowing from the fluid inlet to the fluid outlet; and
(e) a condensate collector for collecting water condensate from the air flowing into the air inlet of the water condenser.

2. The condenser apparatus according to claim 1, wherein:
(a) the airflow driver comprises a fan.

3. The condenser apparatus according to claim 1, wherein:
(a) the airflow driver comprises a plurality of fans.

4. The condenser apparatus according to claim 1, wherein:
(a) the airflow driver drives air through the cross flow heat exchanger and through the water condenser.

5. The condenser apparatus according to claim 1, wherein:
(a) the cross flow heat exchanger provides for removal of sensible heat from the air flowing from the first air inlet to the first air outlet.

6. The condenser apparatus according to claim 1, wherein:
(a) the cross flow heat exchanger provides a reduction in temperature of air of at least 2 degrees F.

7. The condenser apparatus according to claim 1, wherein:
(a) the cross flow heat exchanger provides a reduction in temperature of air of about 2 degrees F. to about 14 degrees F.

8. The condenser apparatus according to claim 1, further comprising:
(a) a bypass opening for allowing air from the air outlet of the water condenser to bypass flow into the second air inlet of the cross flow heat exchanger.

9. A method of removing water from air, the method comprises:
(a) flowing inlet air into a condenser apparatus housing and cooling the inlet air with processed air in a cross flow heat exchanger that separates the inlet air and the processed air and allows heat transfer to provide cooled inlet air;
(b) further cooling the cooled inlet air in a water condenser to remove water from the cooled inlet air and lower the temperature of the cooled inlet air to provide the processed air, wherein the processed air contains less water than the inlet air and is provided at a temperature lower than the inlet air; and
(c) collecting the water removed from the cooled inlet air in the water condenser.

10. The method according to claim 9, wherein:
(a) the inlet air and the processed air flow through the condenser apparatus housing by an airflow driver.

11. The method according to claim 10, wherein:
(a) the airflow driver comprises a fan.

12. The method according to claim 10, wherein:
(a) the airflow driver comprises a plurality of fans.

13. The method according to claim 10, wherein:
(a) the airflow driver drives the inlet air through the cross flow heat exchanger, drives the cooled inlet air through the water condenser, and drives the processed air through the cross flow heat exchanger.

14. The method according to claim 10, wherein:
(a) the cross flow heat exchanger provides for removal of sensible heat from the ambient air.

15. The method according to claim 9, wherein:
(a) the cross flow heat exchanger provides a reduction in temperature of the inlet air of at least 2 degrees F.

16. The method according to claim 9, wherein:
(a) the cross flow heat exchanger provides a reduction in temperature of the inlet air of about 2 degrees F. to about 14 degrees F.

17. The method according to claim 9, further comprising:
(a) allowing the processed air to bypass the cross flow heat exchanger.

18. The method according to claim 17, wherein:
(a) the processed air that bypasses the cross flow heat exchanger is combined with the processed air from the cross flow heat exchanger.

19. The method according to claim 9, wherein:
(a) the processed air from the cross flow heat exchanger is used to remove heat from heat generating environment.

20. The method according to claim 18, wherein:
(a) a mixture of the processed air from the cross flow heat exchanger and the processed air that bypasses the cross flow heat exchanger is used to remove heat from heat generating environment.
